(19) United States
(12) Patent Application Publication
(10) Pub. No.: US 2005/0060544 A1
(43) Pub. Date: Mar. 17, 2005

(54) System and method for digital content management and controlling copyright protection

(76) Inventors: Wen Hsien Huang, Banciao City (TW); Chia-Hsin Cheng, Hsin-Tien City (TW); Chin-Yee Ho, Taipei (TW); Yung-Chang Hsu, Banciao City (TW); Des-Shian Chiu, Taipei (TW)

Correspondence Address: DUANE MORRIS, LLP;IP DEPARTMENT, ONE LIBERTY PLACE, PHILADELPHIA, PA, 19103-7396, US

(21) Appl. No.: 10/895,550

(22) Filed: Jul. 21, 2004

(30) Foreign Application Priority Data
Jul. 22, 2003 (TW) 92119921

(51) Int. Cl. H04L 9/00

(52) U.S. Cl. 713/165

(57) ABSTRACT

A digital content application system comprises a first user means, a second user means and a digital content application platform. The first user means comprises a storage unit and an information management unit. The storage unit stores personal secure information and an electronic file. The electronic file comprises an encrypted digital content and an encrypted symmetric key. The information management unit decrypts the encrypted symmetric key by using the personal secure information so as to generate a symmetric key, and decrypts the encrypted digital content by using the symmetric key for generating a digital content. In conjunction with the decryption of the digital content, the information management unit determines the integrity of the digital content based on two hash values. The digital content application platform receives the digital content from the second user means and transmitting the electronic file to the first user means.

### FIELD OF THE INVENTION

The present invention relates generally to a digital content management system and a method thereof; and more particularly to a system and method for a digital content management which can perform authentication of the digital content, control of copyright protection of the digital content and applications of the digital content.

### BACKGROUND

The human lifestyle is already facing major changes as a consequence of the popularization of computers and networks. For example, the establishment and management of digital data has already replaced the traditional modes of paper usage, the Internet has already become the best method for people to collect data, and people are performing commercial exchanges using the Internet, such as shopping and investing in stocks and downloading information and digital files, etc. Also, as a consequence of the change of modes of recording and broadcasting of data, digital contents, such as data like electronic books and audio-video files, etc., have already become one of the major broadcasting methods.

At present, the method of performing copyright control of a digital content encrypts the digital content and then transmits the digital content to the purchaser. According to the purchaser's secure information, such as a secret code or a secret key, the method decrypts the digital content for generating the original digital content and furthermore analyzes the original digital content. Among well-known methods, the digital content is stored in a computer. The secure information, however, is stored in an IC card or a computer. If the user wants to analyze the digital content, the secure information must be transmitted into the computer which stores the digital content and has the capability of decrypting the digital content. Then the user can access the digital content. However, when the user wants to analyze the digital content on a computer which does not have the secure information and the digital content, it is necessary to load duplicates of the secure information and the digital content into this computer and, furthermore, to install the decryption software in this computer. By the loading and the installation, the user can analyze the digital content.

Due to ease of duplicating of digital content and lack of effective control mechanisms, digital content is extremely easy to duplicate and subject to unauthorized uses. This causes difficulties in managing copyrights of digital contents. Also, no approach for the effective control of copyrights of digital content has been disclosed. Therefore, development and growth of the digital content industry and market are disturbed.

### SUMMARY OF THE INVENTION

A digital content management system comprises a storage unit and an information management unit. The storage unit stores personal secure information and an electronic file. The electronic file comprises an encrypted digital content and an encrypted symmetric key. The information management unit decrypts the encrypted symmetric key by using the personal secure information so as to generate a symmetric key, and decrypts the encrypted digital content by using the symmetric key for generating a digital content.

A digital content application system is disclosed. The digital content application system comprises a first user means associated with a first user, a second user means associated with a second user (e.g., a publisher) and a digital content application platform. The first user means comprises a storage unit and an information management unit. The storage unit stores personal secure information and an electronic file. The electronic file comprises an encrypted digital content and an encrypted symmetric key. The information management unit decrypts the encrypted symmetric key by using the personal secure information so as to generate a symmetric key, and decrypts the encrypted digital content by using the symmetric key for generating a digital content. The second user means comprises an additional storage unit for storing a secret key and a digital content. The second user means provides the digital content and a digital signature corresponding to the digital content. The digital content application platform receives the digital content from the second user means associated with the second user and delivers the electronic file to the first user means associated with the first user.

A digital content management method comprises first providing an electronic file comprising an encrypted digital content and an encrypted symmetric key. The method decrypts the encrypted symmetric key by using personal secure information so as to generate a symmetric key. Then the method decrypts the encrypted digital content by using the symmetric key so as to generate a digital content.

A method to identify integrity of a digital content comprises generating a first hash value according to the digital content. A digital signature is generated according to a secret key corresponding to a user of the digital content and the first hash value. A publicized key is generated corresponding to the secret key corresponding to the user. The digital signature is decrypted by using the publicized key so as to generate a second hash value. The method then determines whether the digital content is modified according to the first and the second hash values.

A method of controlling copyright of a digital content comprises generating a symmetric key. A digital content is encrypted by using the symmetric key. A publicized key is generated corresponding to a user of the digital content. The symmetric key is encrypted by using the publicized key corresponding to the user. The method then combines the encrypted digital content and the encrypted symmetric key as an electronic file.

### BRIEF DESCRIPTION OF THE DRAWINGS

FIG. 1 is schematic drawing showing an exemplary digital content application system.

FIG. 2 is a schematic flowchart showing an exemplary method of a digital signature of a user of a digital content.

FIG. 3 is a schematic flowchart showing an exemplary method to identify the second user and integrity of a digital content by the digital content application platform.

FIG. 4 is a schematic flowchart showing an exemplary method of controlling copyright of a digital content.

FIG. 5 is a schematic drawing showing an exemplary digital content management system.

FIG. 6 is a flowchart showing an exemplary method of decrypting and displaying a digital content.

### DETAILED DESCRIPTION

This description of the exemplary embodiments is intended to be read in connection with the accompanying drawings, which are to be considered part of the entire written description.

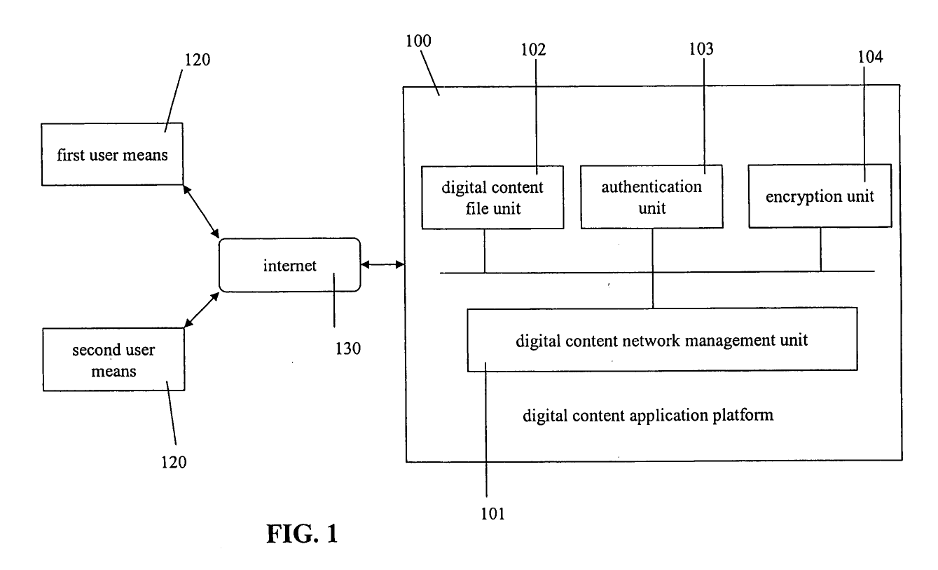

FIG. 1 is schematic drawing showing an exemplary digital content application system. As shown in FIG. 1, the digital content application system includes a first user means 110 associated with a first user and a second user means 120 associated with a second user. The digital content application platform 100 is coupled to the first user means 110 and the second user means 120 via a network 130. A digital content in this embodiment can be an electronic document, or digital electronic data such as an audio-visual file. The first user means 110 and the second user means 120 can be, for example, processors, computers, network computers, memories, servers, or other information system that at least are adapted to store information. The first user and the second user can be, for example, any users who can input passwords or secret information so as to access the digital content application system. They may also represent processors, computers, network computers, memories, servers or the like that are associated with the first and second user and adapted to generate hardware addresses that uniquely identify each node of a network. One of ordinary skill in the art will understand by the context in any given sentence below whether the term “user” in that sentence refers to a person, or an information system associated with that person. In the embodiment described below, the first user represents a customer, a purchaser, a licensee or any person who orders the digital contents, and the second user represents a publisher, a distributor, a licensor, a digital content creator or any person who has rights to control the digital content. One of ordinary skill in the art, after viewing the descriptions of this embodiment, will understand that the definitions of the first user and the second user are not limited thereto.

The digital content application platform 100 is a platform provided to the first user means 1 10 and the second user means 120 for executing digital content applications. The digital content application platform 100 includes a digital content network management unit 101, a digital content file unit 102, an authentication unit 103, and an encryption unit 104. The digital content network management unit 101 is coupled to the digital content file unit 102, the authentication unit 103 and the encryption unit 104. The detailed operations of each unit is explained below. This embodiment constructs a publicized key infrastructure. By this application system, this embodiment furthermore issues a digital certificate respectively to each digital content publisher, agent, and owner, in order to allow the second user means to be able to use this digital certificate to generate a digital signature on the file, and furthermore encrypts the digital certificate of the owner of the digital content in order to prevent it from being analyzed by others. A digital certificate is an attachment to an electronic message used for security purposes which may comprise information such as personal identity of users. All of the digital certificate information can be recorded in the authentication unit 103. The digital content file server 102, the authentication unit 103 and the encryption unit 104 can be, for example, processors, computers, servers, network computers, memories, or the like that are adapted to store information and/or process data.

The recipient of an encrypted message uses the Certificate Authority's (CA's) publicized key to decode the digital certificate attached to the message, verifies it as issued by the CA and then obtains the sender's publicized key and identification information held within the certificate. With this information, the recipient can send an encrypted reply.

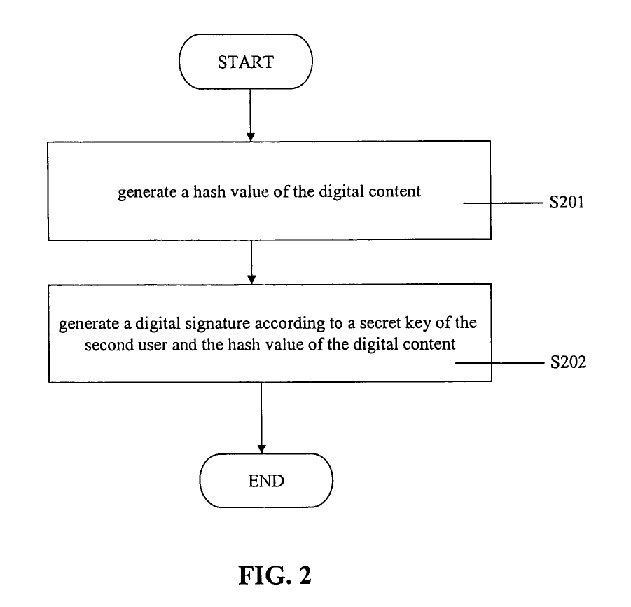

FIG. 2 is a schematic flowchart showing an exemplary method of generating a digital signature corresponding to a second user of a digital content. After receiving the digital content, as in step S201, the second user means 120 computes a hash value of this digital content in accordance with a hash function. After such computation, the secret key of the second user is received, and furthermore as in step S202, a digital signature in accordance with the secret key of the second user is created. Also, the hash value of the digital content is created in order to make a complete digital content having a digital signature. The digital signature of the present embodiment utilizes a symmetric key technology in order to ensure the integrity, non-repudiation, and authenticity of the digital content.

After generating the digital signature on the digital content, the second user means 120 registers the digital signature on the digital content application platform 100, and furthermore transmits the digital content having the digital signature to the digital content network management unit 101 which is in the digital content application platform 100.

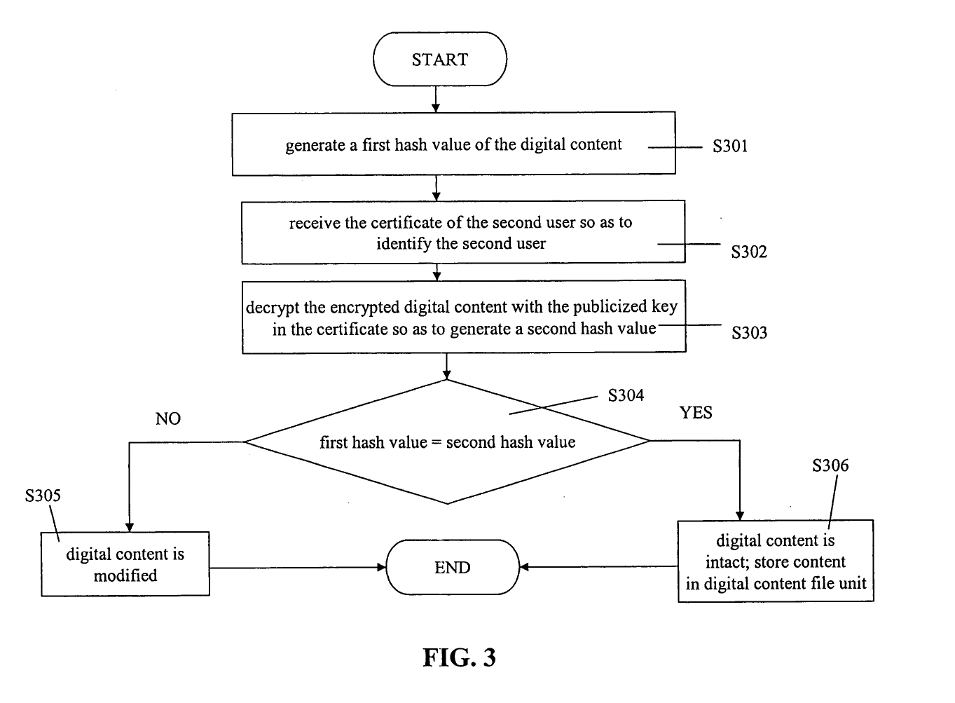

FIG. 3 is a schematic flowchart showing an exemplary method to identify the second user means and integrity of the digital content by the digital content application platform. After receiving the digital content, as in step S301, the digital content application platform 100 directly computes a first hash value of the digital content in accordance with a hash function. In step S302, the digital content application platform 100 acquires the digital certificate of the second user means 120, and furthermore confirms the second user's identity in accordance with identity information of the second user. Then the digital content application platform 100 acquires the publicized key corresponding to the second user in the digital certificate. In step S303, the digital content application platform 100 decrypts the digital signature corresponding to the digital content in accordance with the publicized key of the second user so as to generate a second hash value.

In step S304, the digital content application platform 100 compares the first hash value and the second hash value. When the first hash value is different from the second hash value, it represents a case in which the digital content has already been modified and its integrity is lost as shown in step S305. However, when the first hash value is identical to the second hash value, it represents a case in which this digital content is intact as shown in step S306. Then the digital content application platform 100 stores this digital content in the digital content file unit 102.

As described above, the digital content can be encrypted by using the digital certificate of the first user in order to prevent it from being analyzed or stolen by others. Therefore, after the first user means 110 associate with the first user selects digital content to purchase and download from the digital content application platform 100, the digital content application platform 100 acquires the specified digital content from the digital content file unit 102, and also acquires the digital certificate corresponding to the first user from the authentication unit 103. The digital content application platform 100 transmits the digital content and the digital certificate to the encryption unit 104 in order to perform the related encryption operation.

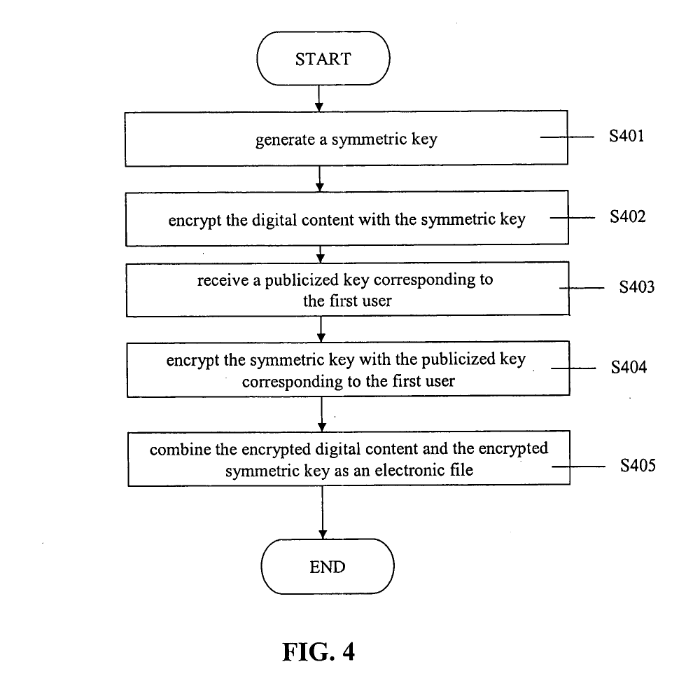

FIG. 4 is a schematic flowchart showing an exemplary method of controlling copyright of a digital content. First, in step S401, the encryption unit 104 generates a symmetric key a random number generation method. In step S402, the encryption unit 104 uses this symmetric key to perform encryption of the digital content so as to generate an encrypted digital content. In step S403, the encryption unit 104 acquires the publicized key corresponding to the first user in the digital certificate. In step S404, the encryption unit 104 uses the publicized key of the first user to perform encryption of the symmetric key so as to generate an encrypted symmetric key. In step S405, the encryption unit 104 combines the encrypted digital content and the encrypted symmetric key as an electronic file.

After the encryption unit 104 completes the encryption operation so as to generate the corresponding electronic file, the digital content application platform 100 transmits this electronic file to the first user means 110. The digital content application platform 100 generates copyright control information in accordance with purchasing conditions of the first user for this digital content. The copyright control information can include an authorization period, printing restriction information, publisher information, digital signature, etc. In addition, the digital content also can be partitioned into plural file partitions, and each file partition can have corresponding copyright control information to control the playback copy access rights of the digital content in that file partition. In addition, the digital content application platform 100 combines the copyright control information into the encrypted digital content. In some embodiments, the copyright control information can be presented by using Extensible Markup Language (XML). In another aspect, the digital content application platform 100 also has corresponding billing and invoicing mechanisms with respect to the first user's actions of purchasing digital content.

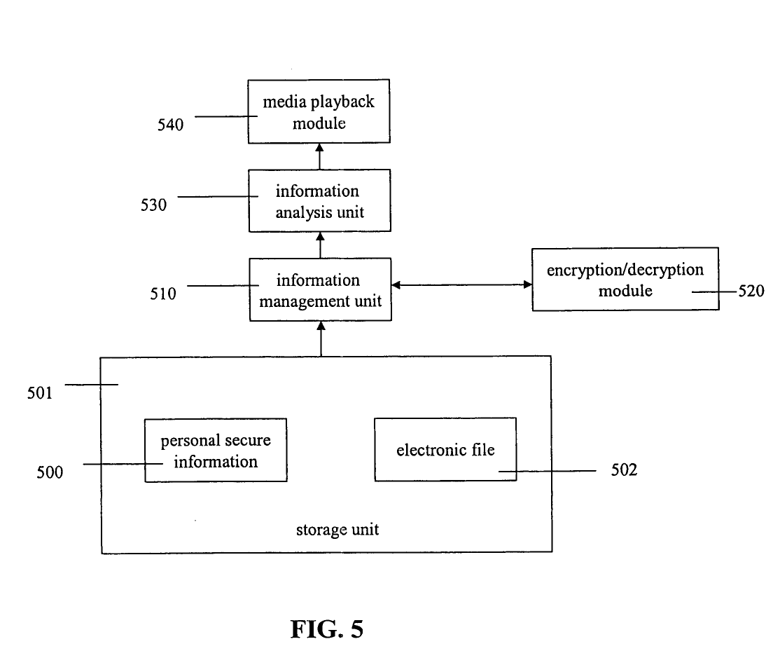

FIG. 5 is a schematic drawing showing an exemplary digital content management system. Referring to FIG. 5, the digital content management system according to this embodiment comprises a storage unit 500, an information management unit 510, an encryption/decryption function module 520, an information analysis module 530, and a media playback module 540.

The storage unit 500 stores personal secure information 501 of the first user, such as a secret key and an electronic file 502, The electronic file 502 includes an encrypted digital content and an encrypted symmetric key. The electronic file 502 is purchased and downloaded from the digital content application platform 100. The information management unit 510 decrypts the encrypted digital content so as to generate the original digital content. The operation is explained in detail below. The encryption/decryption function module 520 provides application programs for cryptographic operations, such as functions for encryption/decryption and signature generation/verification by using a symmetric key or an asymmetric key. The information analysis module 530 performs analysis of digital content, so as to obtain corresponding digital content and copyright control information. The media playback module 540 can be a text browser or an audio-visual player or any media analyzer, or the like, used for performing playback of digital content.

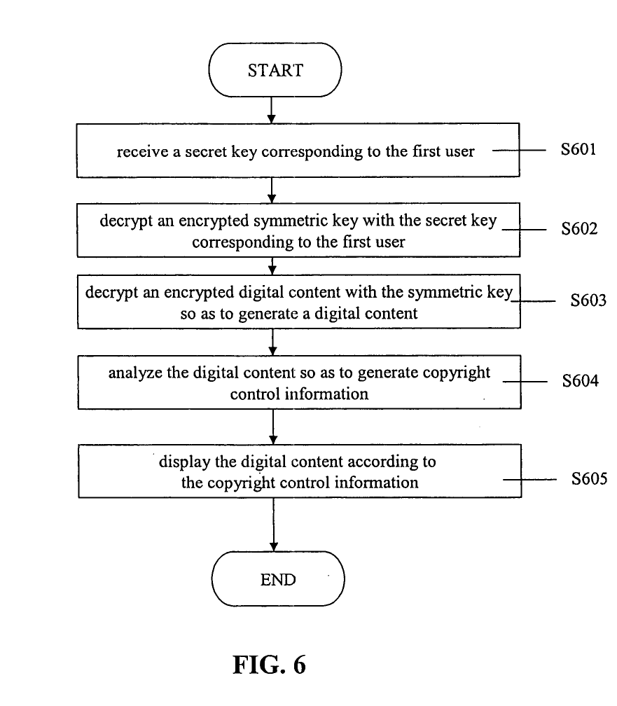

FIG. 6 is a flowchart showing an exemplary method of decrypting and displaying a digital content. When the first user means 110 accesses the digital content, as in step S601, the information management unit 510 receives the secret key (personal secure information 501) corresponding to the first user from the storage unit 500. In step S602, the information management unit 510 performs decryption of the encrypted symmetric key by using the secret key of the first user in accordance with a function provided by the encryption/decryption function module 520 so as to obtain the symmetric key.

In step S603, the information management unit 510 performs decryption of the encrypted digital content by using the symmetric key so as to generate the decrypted digital content. In step S604, the information analysis module 530 performs analysis of the digital content so as to obtain copyright control information corresponding to this digital content. In step S605, the media playback module 540 can display the decrypted digital content in accordance with the copyright control information. The information management unit 510 also can perform verification of the digital content, such as verification of the publisher identity and the integrity of the digital content, the method thereof being as shown in FIG. 3.

The personal secure information of the user, the media playback module and the electronic file can be stored in a portable storage device, such as flash memory, memory disks, or memory sticks, in order to reinforce the effectiveness of digital content copyright control and authorship rights management. By the aid of this technology, it is possible to let the digital content owner be able to carry this portable storage device at any time and analyze and access the digital content on any computer.

Therefore, by the digital content management system and method and application method provided by the examples described above, it is possible to provide a novel type of application of digital content and also perform effective copyright control of digital content. In addition, in the transmission process, the digital content can be confirmed as to the identity of its publisher, and furthermore it can be ensured that its content was not altered and that it cannot be analyzed by non-owners.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A digital content management system, comprising:
a storage unit for storing personal secure information and an electronic file, wherein the electronic file comprises an encrypted digital content and an encrypted symmetric key; and
an information management unit for decrypting the encrypted symmetric key by using the personal secure information so as to generate a symmetric key, and decrypting the encrypted digital content by using the symmetric key for generating a digital content.

2. The digital content management system of claim 1, further comprising a media playback module displaying the digital content.

3. The digital content management system of claim 1, wherein, in conjunction with decrypting the encrypted digital content, the information management unit obtains a digital signature corresponding to a user of the digital content, generates a first hash value corresponding to the digital content, receives a publicized key corresponding to the user, decrypts the digital signature by using the publicized key so as to generate a second hash value, and determines whether the digital content is modified according to the first and the second hash values.

4. The digital content management system of claim 3, wherein the digital signature is generated in accordance with a secret key corresponding to the publicized key and the first hash value corresponding to the digital content.

5. The digital content management system of claim 3, wherein the publicized key corresponding to the user is in a digital certificate corresponding to the user, and the digital certificate comprises identity information corresponding to the user.

6. The digital content management system of claim 1, wherein the encrypted symmetric key is encrypted by using a publicized key corresponding to a user of the digital content, and the personal secure information is a secret key corresponding to the publicized key.

7. The digital content management system of claim 1, wherein the encrypted digital content is encrypted by using the symmetric key.

8. The digital content management system of claim 1, further comprising an information analysis unit for analyzing the encrypted digital content so as to obtain a copyright control information corresponding to the digital content.

9. The digital content management system of claim 8, wherein the digital content comprises a plurality of file partitions, at least one of the file partitions having the copyright control information.

10. The digital content management system of claim 8, wherein the copyright control information comprises an authorization period corresponding to the digital content.

11. The digital content management system of claim 8, wherein the copyright control information comprises printing restriction information corresponding to the digital content.

12. The digital content management system of claim 8, further comprising a media playback module for displaying the digital content according to the copyright control information.

13. The digital content management system of claim 1, wherein the personal secure information and the electronic file are stored in a portable storage device.

14. A digital content application system, comprising:
a first user means associated with a first user, comprising:
a storage unit for storing personal secure information and an electronic file, wherein the electronic file comprises an encrypted digital content and an encrypted symmetric key; and
an information management unit for decrypting the encrypted symmetric key by using the personal secure information so as to generate a symmetric key, and decrypting the encrypted digital content by using the symmetric key for generating a digital content;
a second user means associated with a second user for providing the digital content,; and
a digital content application platform used for receiving the digital content from the second user means and transmitting the electronic file to the first user means .

15. The digital content application system of claim 14, wherein the first user means further comprises a media playback module displaying the digital content.

16. The digital content application system of claim 14, wherein the second user means further comprises an additional storage unit for storing a secret key and the digital content and an additional information management unit for generating a hash value corresponding to the digital content, and generating a digital signature corresponding to the digital content by encrypting the hash value by using the secret key corresponding to the second user.

17. The digital content application system of claim 16, wherein the digital content application platform receives the digital signature corresponding to the digital content from the second user means, generates a first hash value corresponding to the digital content, receives a publicized key corresponding to the secret key, decrypts the digital signature by using the publicized key so as to generate a second hash value, and determines whether the digital content is modified based on the first and the second hash values.

18. The digital content application system of claim 14, wherein the digital content application platform comprises:
a digital content file unit for storing the digital content;
an authentication unit for storing a publicized key corresponding to the second user;
an encryption unit for performing encryption of the digital content; and
a digital content network management unit for being coupled to the digital content file storage unit, the authentication unit, and the encryption unit.

19. The digital content application system of claim 18, wherein the publicized key stored in the authentication unit is in a digital certificate corresponding to the second user, the digital certificate storing identity information corresponding to the second user.

20. The digital content application system of claim 18, wherein the encryption unit generates the symmetric key, encrypts the digital content by using the symmetric key, receives a publicized key corresponding to the first user, encrypts the symmetric key by using the publicized key corresponding to the first user and combines the encrypted digital content by using the encrypted symmetric key as the electronic file.

21. The digital content application system of claim 20, wherein the personal secure information corresponding to the first user is a secret key corresponding to the publicized key corresponding to the first user.

22. The digital content application system of claim 18, further comprising an information analysis unit for analyzing the encrypted digital content so as to generate copyright control information corresponding to the digital content.

23. The digital content application system of claim 22, wherein the digital content comprises a plurality of file partitions, at least one of the file partition having the copyright control information.

24. The digital content application system of claim 22, wherein the copyright control information comprises an authorization period corresponding to the digital content.

25. The digital content application system of claim 22, wherein the copyright control information comprises printing restriction information corresponding to the digital content.

26. The digital content application system of claim 22, wherein the user means further comprises a media playback module for displaying the digital content according to the copyright control information.

27. The digital content application system of claim 14, wherein the personal secure information and the electronic file are stored in a portable storage device.

28. A digital content management method, comprising steps of:
providing an electronic file comprising an encrypted digital content and an encrypted symmetric key;
decrypting the encrypted symmetric key by using personal secure information so as to generate a symmetric key; and
decrypting the encrypted digital content by using the symmetric key so as to generate a digital content.

29. The digital content management method of claim 28, further comprising displaying the digital content.

30. The digital content management method of claim 28, further comprising steps of, in conjunction with the step of decrypting the encrypted digital content:
obtaining a digital signature corresponding to a user of the digital content;
generating a first hash value corresponding to the digital content;
receiving a publicized key corresponding to the user of the digital content;
decrypting the digital signature by using the publicized key so as to generate a second hash value; and
determining whether the digital content is modified according to the first and the second hash values.

31. The digital content management method of claim 30, further comprising a step of generating the digital signature by generating the digital signature in accordance with a secret key corresponding to the publicized key corresponding to the user and the first hash value corresponding to the digital content.

32. The digital content management method of claim 30, further comprising a step of storing the publicized key corresponding to the user in a digital certificate corresponding to the user, the digital certificate comprising identity information corresponding to the user.

33. The digital content management method of claim 28, further comprising steps of encrypting the symmetric key by using a publicized key corresponding to a user of the digital content so as to generating the encrypted symmetric key and encrypting the digital content by using the symmetric key so as to generating the encrypted digital content.

34. The digital content management method of claim 33, wherein the personal secure information is a secret key corresponding to the publicized key corresponding to the user of the digital content.

35. The digital content management method of claim 28, further comprising analyzing the digital content so as to obtain copyright control information corresponding to the digital content.

36. The digital content management method of claim 35, wherein the digital content has plural file partitions, and at least one of the file partitions has the copyright control information.

37. The digital content management method of claim 35, wherein the copyright control information comprises an authorization period corresponding to the digital content.

38. The digital content management method of claim 35, wherein the copyright control information comprises printing restriction information corresponding to the digital content.

39. The digital content management method of claim 35, further comprising displaying the digital content in accordance with the copyright control information.

40. The digital content management method of claim 28, further comprising storing the personal secure information and the electronic file in a portable storage device.

41. A method to identify integrity of a digital content, comprising steps of:
generating a first hash value based on a digital content;
creating a digital signature based on a secret key corresponding to a user of the digital content and the first hash value;
generating a publicized key corresponding to the secret key;
decrypting the digital signature by using the publicized key so as to generate a second hash value; and
determining whether the digital content is modified based on the first and the second hash values.

42. The method to identify integrity of a digital content of claim 41, further comprising receiving a digital certificate corresponding to the user so as to identify the user.

43. The method to identify integrity of a digital content of claim 42, wherein the digital certificate comprises the publicized key.

44. A method of controlling copyright of a digital content, comprising steps of:
generating a symmetric key;
encrypting a digital content by using the symmetric key;
generating a publicized key corresponding to a user of the digital content;
encrypting the symmetric key by using the publicized key corresponding to the user; and
combining the encrypted digital content and the encrypted symmetric key as an electronic file by using the encrypted symmetric key.

45. The method of controlling copyright of a digital content of claim 44, further comprising generating copyright control information corresponding to the digital content.

46. The method of controlling copyright of a digital content of claim 45, wherein the copyright control information comprises an authorization period corresponding to the digital content.

47. The method of controlling copyright of a digital content of claim 45, wherein the copyright control information comprises printing restriction information corresponding to the digital content.

48. The method of controlling copyright of a digital content of claim 45, wherein the digital content has plural file partitions, and at least one of the file partitions has the copyright control information.
